(19) United States
(12) Patent Application Publication
(10) Pub. No.: US 2016/0050442 A1
(43) Pub. Date: Feb. 18, 2016

(54) IN-LOOP FILTERING IN VIDEO CODING

(71) Applicant: Samsung Electronics Co., Ltd., Suwon-si (KR)

(72) Inventors: Ankur Saxena, Dallas, TX (US); Mohammed Aabed, Atlanta, GA (US); Madhukar Budagavi, Plano, TX (US)

(21) Appl. No.: 14/813,849

(22) Filed: Jul. 30, 2015

Related U.S. Application Data
(60) Provisional application No. 62/038,081, filed on Aug. 15, 2014.
(60) Provisional application No. 62/073,654, filed on Oct. 31, 2014.

(51) Int. Cl. H04N 19/82; H04N 19/96; H04N 19/86

(52) U.S. Cl. CPC H04N 19/82; H04N 19/865; H04N 19/96

(57) ABSTRACT

Methods and apparatus for video encoding and decoding. A method for video decoding includes receiving a bit stream for a compressed video and control information for decompression of the video. The method includes identifying a plurality of blocks in a picture of the video based on the control information, each of the blocks having a first size and for each of the blocks, and identifying that one or more of the blocks is divided into a plurality of sub-blocks based on the control information. The method also includes determining whether to apply a filter to pixels in each respective block and each respective sub-block based on the control information. Additionally, the method includes selectively applying the filter to one or more of the blocks and to one or more of the sub-blocks in decoding of the bit stream based on the determination.

### CROSS-REFERENCE TO RELATED APPLICATION(S) AND CLAIM OF PRIORITY

The present application claims priority to U.S. Provisional Patent Application Ser. No. 62/038,081, filed Aug. 15, 2014, entitled “METHODS FOR IN-LOOP FILTERING IN VIDEO CODING”. The present application also claims priority to U.S. Provisional Patent Application Ser. No. 62/073,654, filed Oct. 31, 2014, entitled “METHODS FOR IN-LOOP FILTERING IN VIDEO CODING”. The content of the above-identified patent documents is incorporated herein by reference.

### TECHNICAL FIELD

This disclosure relates generally to video coding and compression. More specifically, this disclosure relates to in-loop filtering in video coding.

### BACKGROUND

In video communication systems, demand for higher quality content is ever present and increasing rapidly. Video resolutions of screens are increasing and so too are the constraints on the communication media used to transfer higher-quality video-resolution content. Video compression encoding is one way to provide increased video quality while reducing the impact of transmitting the content on the communication media. In-loop filters are important processing blocks in video encoders/decoders (codecs), such as High Efficiency Video Coding (HEVC) and H.264 Advanced Video Coding (H.264/AVC). In-loop filters can provide substantial compression gains, as well as provide visual quality improvement in a video codec. The loop filters are often implemented after all the processing blocks in video coding to attempt to remove the artifacts caused by the previous processing blocks, such as quantization artifacts, blocking artifacts, ringing artifacts, etc.

### SUMMARY

Embodiments of the present disclosure provide in-loop filtering in video coding.

In one embodiment, a method for video decoding is provided. The method includes receiving a bit stream for a compressed video and control information for decompression of the video. The method includes identifying a plurality of blocks in a picture of the video based on the control information, each of the blocks having a first size and for each of the blocks, and identifying that one or more of the blocks is divided into a plurality of sub-blocks based on the control information. The method also includes, for each of the blocks and each of the sub-blocks, determining whether to apply a filter to pixels in each respective block and each respective sub-block based on the control information. Additionally, the method includes selectively applying the filter to one or more of the blocks and to one or more of the sub-blocks in decoding of the bit stream based on the determination.

In another embodiment, an apparatus for video decoding is provided. The apparatus includes a receiver and a processor. The receiver is configured to receive a bit stream for a compressed video and control information for decompression of the video. The processor is configured to identify a plurality of blocks in a picture of the video based on the control information, each of the blocks having a first size; identify that one or more of the blocks is divided into a plurality of sub-blocks based on the control information; for each of the blocks and each of the sub-blocks, determine whether to apply a filter to pixels in each respective block and each respective sub-block based on the control information; and selectively apply the filter to one or more of the blocks and to one or more of the sub-blocks in decoding of the bit stream based on the determination.

In another embodiment, an apparatus for video encoding is provided. The apparatus includes a processor and a transmitter. The processor is configured to divide a picture of a video into a plurality of blocks, each of the blocks having a first size; for each of the blocks, determine a compression gain for encoding each respective block for decoding using a filter; encode a bit stream for the video for selective application of the filter to one or more of the blocks during decoding as a function of a threshold level for the determined compression gain; and generate control information indicating whether one or more of the blocks is divided into a plurality of sub-blocks, and which of the blocks to apply the filter to during in-loop filtering in decoding of the bit stream. The transmitter is configured to transmit the bit stream and the control information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” or “processor” means any device, system or part thereof that controls at least one operation. Such a controller or processor may be implemented in hardware or a combination of hardware and software. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in which various embodiments of the present disclosure may be implemented;

FIG. 2 illustrates an example device in a communication system according to this disclosure;

FIG. 3 illustrates a block diagram of a decoder according to illustrative embodiments of this disclosure;

FIGS. 4A and 4B illustrate example video pictures where in-loop filtering is selectively applied to blocks in the pictures according to illustrative embodiments of this disclosure;

FIG. 5 illustrates an example of a quad-tree used for signaling a filter map according to illustrative embodiments of this disclosure;

FIG. 6 illustrates a block diagram of a decoder including a pre-interpolation filter according to illustrative embodiments of this disclosure; and

FIG. 7 illustrates a graph for an example of an entropy-based analysis for activity-based thresholding in filter application according to illustrative embodiments of this disclosure.

### DETAILED DESCRIPTION

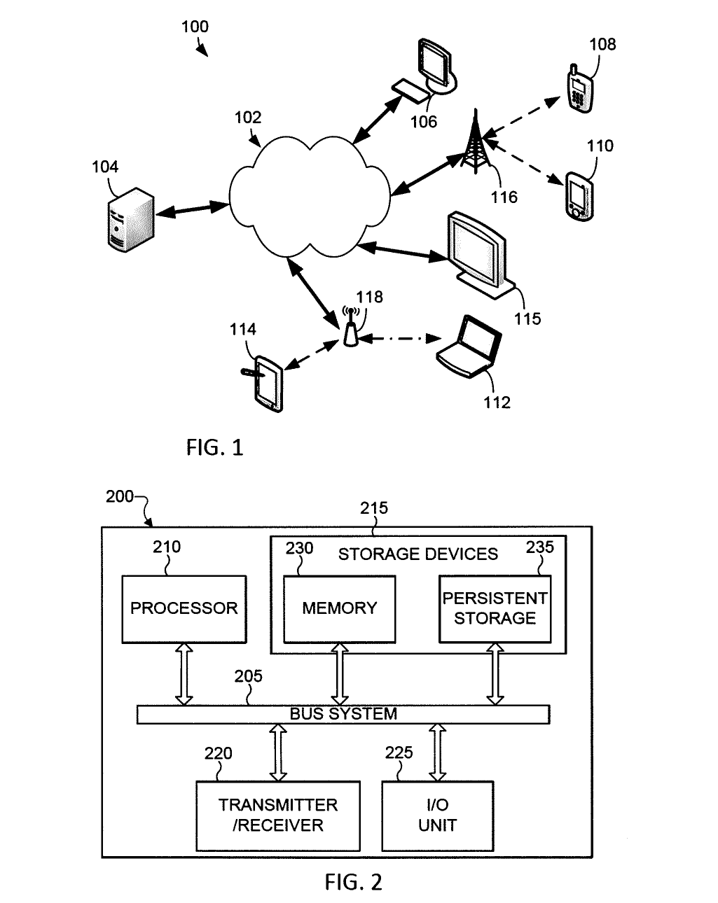

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

FIG. 1 illustrates an example communication system 100 in which various embodiments of the present disclosure may be implemented. The embodiment of the communication system 100 shown in FIG. 1 is for illustration only. Other embodiments of the communication system 100 could be used without departing from the scope of this disclosure.

As shown in FIG. 1, the system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may also be a heterogeneous network including broadcasting networks, such as cable and satellite communication links. The network 102 may include one or more local area networks (LANs); metropolitan area networks (MANs); wide area networks (WANs); all or a portion of a global network, such as the Internet; or any other communication system or systems at one or more locations.

The network 102 facilitates communications between at least one server 104 and various client devices 106-115. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-115 represents any suitable computing or processing device that interacts with at least one server or other computing device(s) over the network 102. In this example, the client devices 106-115 include a desktop computer 106, a mobile telephone or smartphone 108, a personal digital assistant (PDA) 110, a laptop computer 112, a tablet computer 114; a set-top box and/or television 115, a media player, a media streaming device, etc. However, any other or additional client devices could be used in the communication system 100.

In this example, some client devices 108-114 communicate indirectly with the network 102. For example, the client devices 108-110 communicate via one or more base stations 116, such as cellular base stations or eNodeBs. Also, the client devices 112-115 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

As described in more detail below, network 102 facilitates communication of media data, for example, such as images, video, and/or audio, from server 104 to client devices 106-115. For example, the media data may be a bit stream of compressed video data. Additionally, the server 104 may provide control information for decompression of the video together with or separately from the bit stream of compressed video data.

Although FIG. 1 illustrates one example of a communication system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

FIG. 2 illustrates an example device in a communication system according to this disclosure. For example, the device 200 in FIG. 2 may be an encoder or a decoder for encoding and sending compressed video data or receiving and decoding compressed data over the network 102, such as the server 104 and/or the client devices 106-115 in FIG. 1. As described in more detail below, the device 200 may encode or decode video data and/or transmit or receive compressed video data and control information for decompression of the video data.

As shown in FIG. 2, the device 200 includes a bus system 205, which supports communication between at least one processor 210, at least one storage device 215, at least one transmitter/receiver 220, and at least one input/output (I/O) unit 225.

The processor 210 executes instructions that may be loaded into a memory 230. The processor 210 may include any suitable number(s) and type(s) of processors or other devices in any suitable arrangement. Example types of processor 210 include microprocessors, microcontrollers, digital signal processors, field programmable gate arrays, application specific integrated circuits, and discreet circuitry. The processor 210 may be a general-purpose CPU or specific purpose processor for encoding or decoding of video data.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a read-only memory, hard drive, Flash memory, or optical disc.

The transmitter/receiver 220 supports communications with other systems or devices. For example, the transmitter/receiver 220 could include a network interface card or a wireless transceiver facilitating communications over the network 102. The transmitter/receiver 220 may support communications through any suitable physical or wireless communication link(s). The transmitter/receiver 220 may include only one or both of a transmitter and receiver, for example, only a receiver may be included in a decoder or only a transmitter may be included in an encoder.

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

As will be discussed in greater detail below, embodiments of the present disclosure provide methods for in-loop filtering in video coding. Embodiments of the present disclosure further provide different types of in-loop filters and methods for determining when to apply the different types of loop filters. In various embodiments, the filter may be a bilateral filter, which is a non-linear filter and can capture the non-linear distortions introduced by a quantization module which may not be captured by other filters. The filter may be a fixed filter that may not be limited to the luma channel but also applied to any color channel or depth channel. In other embodiments, a mean filter, a-trimmed, median, or separable bilateral filters may be used. In such embodiments, vertical filtering can be performed first followed by horizontal filtering, or vice versa.

In various embodiments, different loop filters can also be selectively applied based on a rate-distortion search at the encoder, or the picture (or frame) type such as Intra, Inter P, or B pictures, etc. In various embodiments, different loop filters can also be selectively applied based on the resolution (e.g., HD, 2K, 4K, 8K, etc.) of the video sequences. In various embodiments, different loop filters can also be applied depending on the quantization parameter used for the block. The loop filters described herein are not limited in application to single layer video coding. The loop filters of the present disclosure can be used after up-sampling images, e.g., in scalable video coding, etc.

In various embodiments, a 3-tap (e.g., [1 2 1]/4) separable filter can be applied along both the horizontal and vertical directions as the loop filter. Such a filter has a low complexity, as this filter can be implemented via adds and shifts only, and no multiplications and division operations may be required. This 3-tap filter can also be used as a pre-interpolation filter, which can be switched ON or OFF at a coding unit (CU) level based on improvement of the rate-distortion performance for that CU.

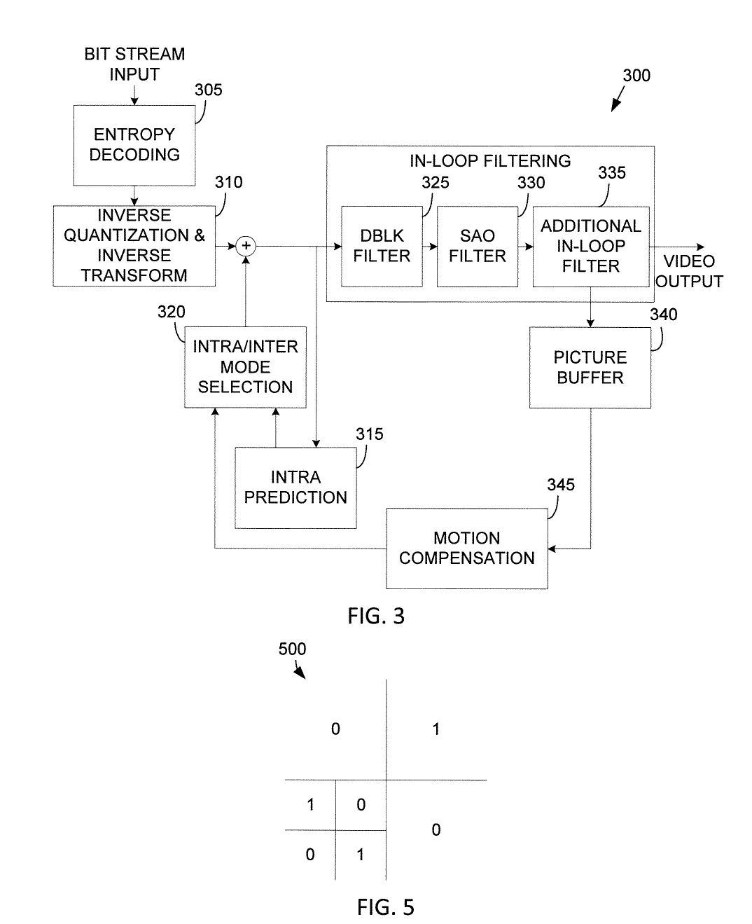

FIG. 3 illustrates a block diagram of a decoder 300 according to illustrative embodiments of this disclosure. In this illustrative embodiment, the decoder 300 may be implemented by the processor 210 in FIG. 2 to decode a bit stream input according to a video coding standard, such as, for example, the HEVC standard or some other video coding standard, and provide a video output for presentation to a user display device.

The decoder 300 receives (e.g., via receiver 220) a bit stream input of compressed video data and performs entropy decoding via entropy decoding block 305 and inverse quantization and inverse transform via inverse quantization and inverse transform block 310. The decoder 300 performs Intra prediction and Intra/Inter mode selection via Intra prediction block 315 and Intra/Inter mode selection block 320, respectively. For Intra prediction mode, the prediction of the blocks in the picture is based only on the information in that picture whereas, for Inter prediction, prediction information is used from other pictures.

The decoder 300 performs loop filtering of the picture using various filters 325, 330, and 335. For example, in the HEVC standard, two in-loop filters are used, a deblocking (DBLK) filter 325 and a sample adaptive offset (SAO) filter 330. Embodiments of the present disclosure provide an additional (or third in-loop filter) in-loop filter (AILF) 335, which may be selectively applied according to explicit or implicit control information, as will be discussed in greater detail below, to increase bitrate savings and coding efficiencies. After in-loop filtering, the filtered picture is stored in picture buffer 340 for motion compensation via motion compensation block 345 and stored as a reference for Intra/Inter mode selection 320.

While FIG. 3 illustrates an embodiment in which AILF 335 is applied after SAO filter 330, the AILF 335 can be applied before DBLK filter 325 or between DBLK filter 325 and SAO filter 330. Also, if other filters are applied after SAO filter 330, the AILF 335 can be applied before or after these other filters. In various embodiments, the AILF 335 may be, for example and without limitation, a bilateral filter (BLF), a median filter, a Gaussian filter, a mean filter, or a α—trimmed filter.

In one or more embodiments, the AILF 335 employs a mean-square error (MSE) based BLF design. In these embodiments, the AILF 335 uses a BLF in a MSE frame work. For example, the AILF 335 may operate based on Equation 1 below:

$$\begin{matrix}J ( x ) = \frac{1}{k ( x )} {\sum }_{y ∈ N ( x )} {e}^{\frac{- {‖ y - x ‖}^{2}}{2 {σ}_{d}^{2}}} \cdot {e}^{\frac{- {‖ I ( y ) - I ( x ) ‖}^{2}}{2 {σ}_{r}^{2}}} \cdot I ( y ) \\ = \frac{1}{k ( x )} {\sum }_{y ∈ N ( x )} f ( y - x ) \cdot g ( I ( y ) - I ( x ) ) \cdot I ( y )\end{matrix} \qquad [ Equation 1 ]$$

where the input to the AILF 335 is Image I, and I(x), I(y) denote the intensity value at a particular (2-d) pixel x, y, etc. Parameter τ_{d} denotes the standard deviation in Euclidian-domain and governs how the filter strength decreases as we start moving away from the pixel x which is going to be filtered. Parameter τᵣ denotes the standard deviation in the range-domain and governs how the filter strength decreases as movement away from the intensity of pixel I(x) in the range (intensity) space occurs. Also, N(x) denotes the neighborhood for pixel x which is used for filtering x, and k(x) is a normalization factor.

For I(x) and Iₛ(x) denoting the original picture and intermediate reconstructed picture after SAO, respectively, and I_{B}(x) denoting the picture which is obtained by filtering Iₛ (x), the picture into non-overlapping blocks of size K×K (e.g., K=8, 16, 32, 64, etc.) where the total number of the K×K blocks is B. In case the picture height or width is not an exact multiple of K, the decoder 300 can perform processing over the remaining last L (L<K) samples along a dimension, or the remaining samples as is (i.e., do not filter using AILF 335).

Next, for each block bεB, either one of the set of pixels in Iₛ(x) or I_{B}(x) are chosen by the encoder as I_{R}(x), and the encoder sets a flag (flag_{AILF}) based on Equation 2 below such that:

$$if ( {\sum }_{x ∈ b} {( I ( x ) - {I}_{S} ( x ) )}^{2} > {\sum }_{x ∈ b} {( I ( x ) - {I}_{B} ( x ) )}^{2} ) \\ {I}_{R} ( x ) = {I}_{B} ( x ) and {flag}_{AILF} = 1 x ∈ b \\ else \\ {I}_{R} ( x ) = {I}_{S} ( x ) and {flag}_{AILF} = 0 x ∈ b \qquad [ Equation 2 ]$$

The flag_{AILF} is a bit for each of the B blocks. The flag_{AILF} can be implicitly or explicitly signaled to the decoder 300 in control information, for example, by doing entropy coding and/or using context. Also, appropriate initialization of the context can be performed.

Note that in the above example, the distortion (e.g., MSE) is minimized or reduced and did not include a rate term for the bits. Also, note that instead of the distortion metric, some other metric, such as sum-of-absolute-differences (SAD) and/or a perceptual metric, such as, for example, without limitation, structural similarity (SSIM) can be used.

Once the control information is decoded at the decoder 300, e.g., the flag_{AILF} for each block, the decoder 300 can filter all the pixels in that block after the SAO filter 330 output using AILF 335 if the flag is 1. Otherwise, if the flag is 0, the decoder 300 will not apply the AILF 335 for that block. Additionally, the AILF 335 application can be implemented for the Luma channel as well as Chroma channels separately (e.g., 3 different flags may be sent for the one Luma and two Chroma channels) or jointly (e.g., one flag per Luma block may be sent).

Testing and simulation results have generally indicated that under certain applications of the AILF 335, compression gains are better for larger block sizes (e.g., 32×32 vs. 8×8 block sizes) among different video resolutions. Additionally, the compression gains without encoding the control information (e.g., the flag bits as overhead) present additional compression gains indicating that the overhead associated with indicating which blocks to apply the AILF 335 to (the AILF map) is significant particularly with the smaller block sizes. For example, greater compression gains may be achieved via application of the AILF 335 based on smaller block sizes; however, the overhead associated with indicating the AILF application may significantly impact the compression gains to the point that larger block sizes have a greater net (i.e., considering signaling overhead for the AILF application) gain. Additionally, testing and simulation can be performed in advance or periodically to find the optimal operational parameters for the AILF 335 including, for example, parameters for domain standard deviation, τ_{d}, range standard deviation, τᵣ, and filter size. In one example, at block size without overhead, and All Intra mode, the following representative τ_{d}=1.5, τᵣ=0.03 was found to be optimum.

Such parameters can be signaled in the control information in advance of the video data transmission and calibrated periodically, or these parameters may be modified and signaled per video transmission, picture, or block.

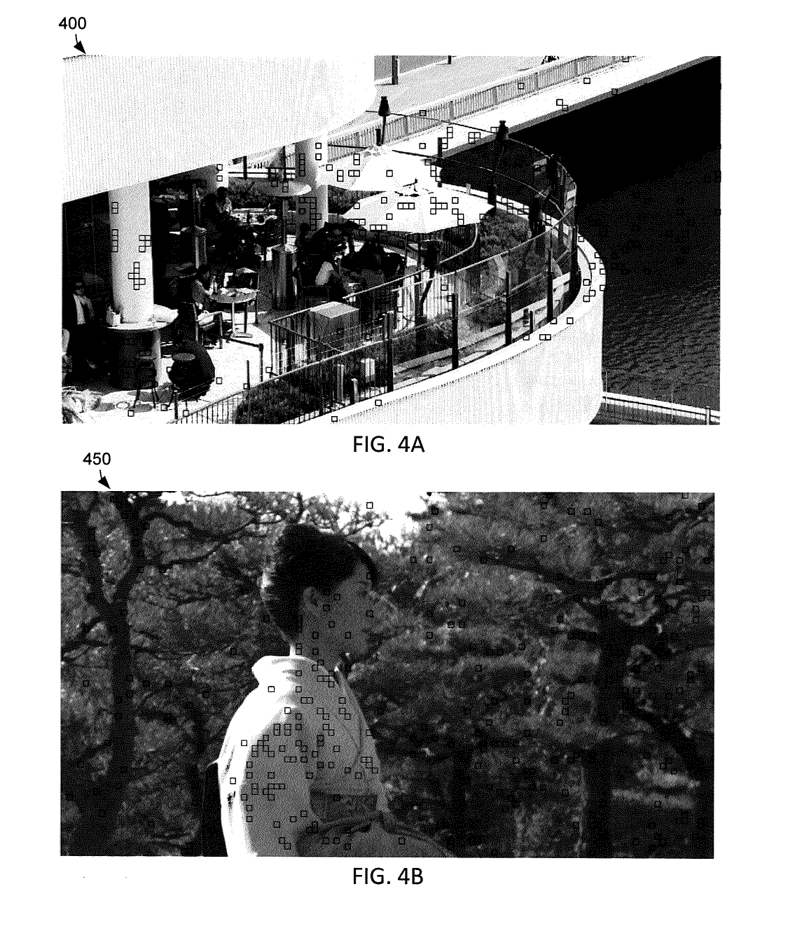

Accordingly, various embodiments of the present disclosure provide for reduction in overhead needed to signal the control information for whether to apply the AILF 335 for a given block through both explicit and implicit schemes. In one or more embodiments, explicit rate-distortion (R-D) based techniques are used to reduce overhead. In general, the overhead bits for signaling the AILF 335 application on a per-block basis is large. Prediction can be performed to reduce these bits. Such is performed in the context of entropy coding of context-adaptive binary arithmetic coding (CABAC) to estimate the current bit in probabilistic sense. Additional or alternative techniques are based on the assumption that AILF 335 is generally applied in near-by regions (see e.g., FIGS. 4A and 4B).

FIGS. 4A and 4B illustrate example video pictures where AILF 335 is selectively applied to blocks in the pictures according to illustrative embodiments of this disclosure. The outlined blocks in the pictures 400 and 450 are blocks to which AILF 335 is applied. As illustrated, AILF applied blocks more frequently occur at transitions between different objects or objects that are moving.

Various embodiments of the present disclosure utilize these observations to reduce signaling overhead. For example, if the smallest block size was 8×8 where AILF 335 was operated, four adjoining regions may be combined into one region with one flag indicating AILF application 4 flags. Similarly, for larger regions of non-application of AILF 335, these multiple regions can be combined, and a single flag can be sent for a larger region. Additionally, it is possible that the distortion improvement is minor for a block, while the additional rate to signal AILF application is larger. Hence, various embodiments provide a framework in which the explicit R-D cost=D+λ*R is reduced or minimized, where D denotes the Mean-squared distortion, R is the bit-rate (including overhead bits), and λ denotes the Lagrangian parameter (e.g., dependent on picture quantization parameter).

FIG. 5 illustrates an example of a quad tree 500 used for signaling a filter map according to illustrative embodiments of this disclosure. Various embodiments use a quad tree-based algorithm for signal AILF application to reduce overhead based on the fact that AILF application commonly occurs in near-by regions. This example quad tree 500 is constructed to indicate the AILF map of flags in the picture, with a 1 indicating that the AILF 335 is applied to the block and a 0 indicating that the AILF 335 is not applied to the block. Each region in the quad tree 500 represents a block to which AILF 335 may be applied, and the different sizes of the regions represent different block depths. For example, the entirety of the quad tree may be a block size of 32×32 at a depth of 0, where the depth 1 block is 16×16, and the smallest block size illustrated at a depth 2 is 8×8. The example quad tree 500 illustrated has a depth of 3; however, any depth may be used.

In utilizing the quad tree 500, the encoder determines, for the largest block size, the R-D costs not using AILF for the entire block, the R-D cost associated with using AILF for the entire block, and the R-D cost associated with splitting the block into 4 children blocks (e.g., assumed to be half dimension in each width and height, but could be other sizes that are explicitly or implicitly signaled). Based on the determined R-D costs, the encoder selects the appropriate option for the block and indicates the selective application of the AILF in control information. The above process is followed recursively until the maximum depth (smallest block size) is reached.

For example, the signaling format may be that “0” indicates that all blocks below the current depth do not use AILF, “11” indicates that all blocks below the current depth use AILF, and “10” indicates that the block is split into 4 children blocks. For the example quad tree 500, based on this example signaling format and using a left-right top-bottom orientation, the AILF applicant may be signaled as 10 0 11 10 1001 0 (with annotations: 10—block split to next depth i.e., 4 blocks for quad tree 500; 0—start at upper left block of quad tree 500 with no AILF applied; 11—apply AILF to upper right block; 10—split lower left block into 4 blocks; 1001—flags for each of the 4 lower left blocks at the maximum depth/smallest block; 0—no AILF application to lower right block. The above format is for the purpose of illustrating one example, but other formats may be used including proceeding using a clockwise, counter-clockwise, top down, left/right, or other orientation, and different flag values may be used.

Once the quad tree 500 is constructed at the encoder via the R-D cost analysis, the blocks which are actually filtered by AILF are indicated by the AILF map. For example, in the quad tree 500, only the blocks with 1 will be filtered while the others will not be filtered. To explicitly find this, at the encoder and similarly at the decoder 300, the control information indicating the selective application of the AILF 335 (e.g., the “AILF bit-stream”) is parsed, and the output map for all the blocks is assigned as 1 or 0 using an appropriate algorithm, which may be stored by both the encoder and decoder.

In various embodiments, the overhead signaling of the 2 bits at the various depths and one bit at the maximum depth or smallest block size (i.e., 0 or 1) based on signaling above in the quad tree may be further reduced by using context for each of the bits separately. Further, efficient initialization of these contexts can be done by using the statistics of these bits which can be obtained from the decoder and averaged over multiple sequences, frames, etc.

As discussed above, the quad tree-based signaling; the AILF parameters, such as τ_{d}, τᵣ and filter size; and maximum and minimum depths may be selected and/or modified to further improve or optimize compression gains. In experimentation, the following BLF parameters of τ_{d}=1.4, τᵣ=7.65 and filter size 3×3 while maxDepth is 128 and minDepth is 16 were found be optimal. Note that these are just representative parameters, and other parameters which may improve the coding efficiency can be used.

Also, different filters, such as a Gaussian (with some standard deviation), a mean, a median, or a α-trimmed order statistic genre of filter may be used. Further, low-complexity versions of bilateral filtering, such as separable BLF and those which avoid the division operation by using a fixed look-up-size table can also be used.

In practice, the implementation of some filters, such as, for example, a bilateral filter may be expensive in hardware, as the filter coefficients are not fixed, and dependent on the pixel intensity values in addition to the distance from the pixel being filtered. Still other filters which have lower complexity can be used. The Gaussian filter, where the variation is only based on the Euclidian distance and not on pixel intensity, can be used as the AILF 335. As the Gaussian filter can have fixed coefficients, the Gaussian filter may be implemented in hardware more easily.

Additionally, a mean filter which takes the mean of the pixels used by the filtering kernel (window) can be used as AILF 335. However, both the Gaussian and mean filters still have a division operation for normalization. For example, a 3×3 mean filter will imply a division by 9 as 9 pixels will be used for the filtering operation.

To avoid the division operation, various embodiments of the present disclosure use a separable 3-tap filter along each of the vertical and horizontal directions. For example, a [1, 2, 1]/4 filter can be used along both horizontal and vertical directions. Further, the 3-tap filter may be applied as a 2-d filter in one step based on Equation 3 below:

$${( 1 / 16 )}^{*} [ \begin{matrix}1 & 2 & 1 \\ 2 & 4 & 2 \\ 1 & 2 & 1\end{matrix} ] \qquad [ Equation 3 ]$$

This filter can be implemented via simple addition and shift operations, as all the numbers are powers of 2; and division by 4 or 16 can be replaced by a shift. This reduced complexity implementation may provide advantages over other fixed coefficient filters, such as mean and Gaussian filters.

In experimentation amongst various bilateral filters, the following parameters were found to be the optimal: window size of filter: 3×3; τ_{d}=1.4, τᵣ=7.65. For the Gaussian filter, τ_{d}=1.4 was found to be optimal; again at filter window size 3×3. For the mean filter, again the 3×3 filter window size was found to be optimal. These parameters are just examples of parameters that may be used; any other parameters that improve coding efficiency may be used.

Ultimately, the filter used in the AILF 335 may be selected based on the tradeoffs of performance versus complexity in implementation for a given application. In various embodiments, simulation results indicate that use of a bilateral filter for AILF 335 may perform best on I and B frames, while the use of Gaussian filter may perform for the AILF 335 best on P frames. Hence, a frame level flag can be used to indicate which filter will be used for that particular frame.

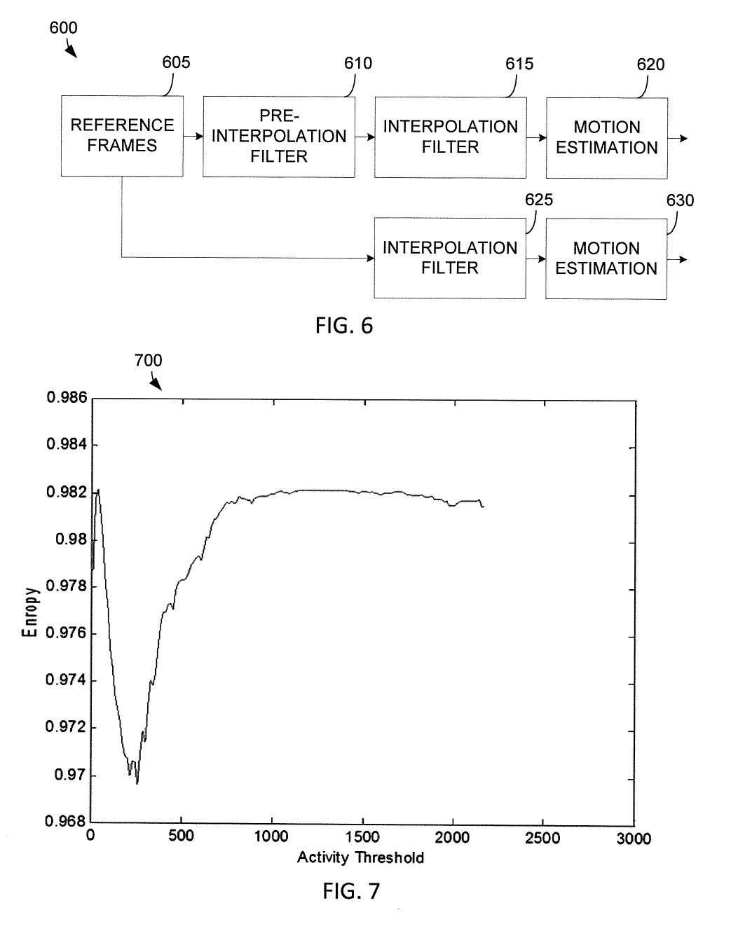

FIG. 6 illustrates a block diagram of a decoder 600 including a pre-interpolation filter 610 according to illustrative embodiments of this disclosure. In various embodiments of the present disclosure, the above discussed 3-tap filter may additionally or alternatively be used as a pre-interpolation filter 610. For example, to remove the noise during interpolation process, pre-interpolation filter 610 can be employed before the interpolation filter 615 at the decoder 600. The encoder performs a R-D analysis to determine whether the pre-interpolation filter 610 improves the overall quality of the decoded picture at the same bit-rate and transmits a pre-interpolation filter flag (e.g., preIntFilterFlag=1) to the decoder, if the pre-interpolation filter improves the picture quality. Thus, the decoder 600 applies pre-interpolation filter 610 to reference frames 605 before interpolation filter 615 and motion estimation block 620. Otherwise, the decoder transmits a different flag (e.g., preIntFilterFlag=0). The decoder 600 parses the flag and uses the pre-interpolation filter 610 if the flag was 1, else the decoder 600 does not use the pre-interpolation filter 610 and applies interpolation filter 625 and motion estimation block 630 to reference frames 605.

Various embodiments of the present disclosure also provide implicit techniques to reduce overhead in signaling of control information for application of the AILF 335. For example, activity features, may be implicitly known to have the AILF 335 applied during decoding, whereas inactive areas of the picture will not have AILF 335 applied. In other examples, the entropy of setting an activity-based threshold to signal application of the AILF 335 may be calculated and signaled for specific pictures and/or video transmissions. In this example embodiment, the decoder 300 has a predefined or encoder-signaled threshold for the activity index in the block based on which it would apply the AILF 335.

FIG. 7 illustrates a graph for an example of an entropy-based analysis for activity-based thresholding in filter application according to illustrative embodiments of this disclosure. In this illustrative example, graph 700 illustrates the entropy as a function of an activity threshold. For example, beyond a certain activity threshold, the entropy increases. Therefore, the probability and entropy of the utility of this approach for a range of activity thresholds may be calculated according to Equation 4 below:

H(threshold)=−[p₀(q₀ log₂q₀+(1−q₀) log₂(1−q₀))+(1−p₀)(m₀ log₂m₀+(1−m₀) log₂(1−m₀))] [Equation 4]

where H is the entropy, Pr[activity≦threshold]=p₀, Pr[ON|activity≦threshold]=q₀, Pr[ON|activity>threshold]=m₀, and Pr is the probability.

For a given picture/frame or video transmission, this activity threshold can be calculated or set in advance and signaled in control information for implicitly signaling when to apply the AILF 335 during decoding of the bit stream of video data. The decoder 300 then calculates the activity level of a block in a picture and determines whether to apply the AILF 335 to the block as a function of the activity threshold.

In other embodiments, the one or more of the above-discussed filtering schemes can be applied on non-rectangular blocks. Still in other embodiments, the decoder 300 may apply more than one type of filter to perform the filtering at AILF 335. The filter applied may be selected based on a R-D analysis or some implicit criteria at the encoder. In these embodiments, a modified quad tree can be used to additionally include filter selection, or a picture/largest block level switch between the filters can be used. In yet other embodiments, the same filter, for example, the BLF, can be used for the AILF 335, but with different block sizes or parameters, such as different standard deviation in range or domain space.

Embodiments of the present disclosure provide a filter and method of selectively applying the filter to blocks of a picture for encoding and decoding video data. Use of a non-linear quad-tree based bilateral filter, in some embodiments, can capture the non-linear distortions introduced by quantization module which may not be otherwise captured. The quad-tree based AILF provided by embodiments of the present disclosure provides significant compression gains to one or more video resolution sequences. The AILF provided by embodiments of the present disclosure can also have a small window size reducing implementation complexity and the number of operations performed per pixel during the filtering of the pixels.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for video decoding, the method comprising:
receiving a bit stream for a compressed video and control information for decompression of the video;
identifying a plurality of blocks in a picture of the video based on the control information, each of the blocks having a first size;
identifying that one or more of the blocks is divided into a plurality of sub-blocks based on the control information;
for each of the blocks and each of the sub-blocks, determining whether to apply a filter to pixels in each respective block and each respective sub-block based on the control information; and
selectively applying the filter to one or more of the blocks and to one or more of the sub- blocks in decoding of the bit stream based on the determination.

2. The method of claim 1, wherein:
selectively applying the filter comprises applying the filter to one or more sub-blocks as an additional in-loop filter (AILF), and
the AILF is applied or not applied on a block or sub-block based on value of a filter-flag obtained from the control information.

3. The method of claim 2, wherein determining whether to apply the filter to the pixels in each respective block comprises determining whether to apply the filter as a function of a threshold level of activity in each respective block.

4. The method of claim 2, wherein:
a maximum and minimum height/width of the blocks on which the filter is applied is 128 and 16 respectively, and
the filter is one of (i) a 3×3 non-separable bilateral filter with filter parameters τ_{d}=1.4, τᵣ=7.65; (ii) a mean filter with window size 3×3; or (iii) a Gaussian filter with window size 3×3 and τ_{d}=1.4, where τ_{d} is a domain standard deviation and τᵣ is a range standard deviation.

5. The method of claim 2, wherein the filter is a separable three-tap filter with filter coefficients [1,2,1]/4 along both horizontal and vertical directions.

6. The method of claim 2, further comprising:
identifying a frame type of one or more frames in the video; and
selecting the filter to apply from a group of filters based on the identified frame type.

7. The method of claim 1, wherein the filter is a separable three-tap filter with coefficients [1,2,1]/4 along both horizontal and vertical directions, and the separable three-tap filter is used as a pre-interpolation filter applied before interpolation processing of the bit stream according to the control information received.

8. An apparatus for video decoding, the apparatus comprising:
a receiver configured to receive a bit stream for a compressed video and control information for decompression of the video; and
a processor configured to identify a plurality of blocks in a picture of the video based on the control information, each of the blocks having a first size; identify that one or more of the blocks is divided into a plurality of sub-blocks based on the control information; for each of the blocks and each of the sub-blocks, determine whether to apply a filter to pixels in each respective block and each respective sub-block based on the control information; and selectively apply the filter to one or more of the blocks and to one or more of the sub-blocks in decoding of the bit stream based on the determination.

9. The apparatus of claim 8, wherein the processor is configured to apply the filter to one or more sub-blocks as an additional in-loop filter (AILF), and the AILF is applied or not applied on a block or sub-block based on value of a filter-flag obtained from the control information.

10. The apparatus of claim 9, wherein the processor is configured to determine whether to apply the filter as a function of a threshold level of activity in each respective block.

11. The apparatus of claim 9, wherein:
a maximum and minimum height/width of the blocks on which the filter is applied is 128 and 16 respectively, and
the filter is one of (i) a 3×3 non-separable bilateral filter with filter parameters τ_{d}=1.4, τᵣ=7.65; (ii) a mean filter with window size 3×3; or (iii) a Gaussian filter with window size 3×3 and τ_{d}=1.4, where τ_{d} is a domain standard deviation and τᵣ is a range standard deviation.

12. The apparatus of claim 9, wherein the filter is a separable three-tap filter with filter coefficients [1,2,1]/4 along both horizontal and vertical directions.

13. The apparatus of claim 9, wherein the processor is configured to:
identify a frame type of one or more frames in the video; and
select the filter to apply from a group of filters based on the identified frame type.

14. The apparatus of claim 8, wherein the filter is a separable three-tap filter with coefficients [1,2,1]/4 along both horizontal and vertical directions and the separable three-tap filter is used as a pre-interpolation filter applied before interpolation processing of the bit stream according to the control information received.

15. An apparatus for video encoding, the apparatus comprising:
a processor configured to divide a picture of a video into a plurality of blocks, each of the blocks having a first size; for each of the blocks, determine a compression gain for encoding each respective block for decoding using a filter; encode a bit stream for the video for selective application of the filter to one or more of the blocks during decoding as a function of a threshold level for the determined compression gain; and generate control information indicating whether one or more of the blocks is divided into a plurality of sub-blocks, and which of the blocks and the sub-blocks to apply the filter to in decoding of the bit stream; and
a transmitter configured to transmit the bit stream and the control information.

16. The apparatus of claim 15, wherein the processor is configured to determine whether to encode the bit stream for application of the filter to one or more of the blocks as a function of a threshold level of activity in each respective block.

17. The apparatus of claim 15, wherein the filter is a separable three-tap pre-interpolation filter with filter coefficients [1,2,1]/4 along both horizontal and vertical directions.

18. The apparatus of claim 15, wherein:
a maximum and minimum height/width of the blocks on which the filter is to be applied is 128 and 16 respectively, and
the filter is one of (i) a 3×3 non-separable bilateral filter with filter parameters τ_{d}=1.4, τᵣ=7.65; (ii) a mean filter with window size 3×3; or (iii) a Gaussian filter with window size 3×3 and τ_{d}=1.4, where τ_{d} is a domain standard deviation and τᵣ is a range standard deviation.

19. The apparatus of claim 15, wherein the filter is selectively applied based on a frame type of a frame in the video.

20. The apparatus of claim 15, wherein:
the filter is applied as an additional in-loop filter (AILF), and
the AILF is applied or not applied on a block or sub-block based on value of a filter-flag included in the control information.
